(19) United States
(12) Patent Application Publication
(10) Pub. No.: US 2004/0158405 A1
(43) Pub. Date: Aug. 12, 2004

(54) System of processing and presenting drill hole data

(76) Inventor: Swie Djin Nio, Huis ter Heide (NL)

Correspondence Address: PEACOCK MYERS AND ADAMS P C, P O BOX 26927, ALBUQUERQUE, NM, 871256927

(21) Appl. No.: 10/634,373

(22) Filed: Aug. 4, 2003

Related U.S. Application Data
(63) Continuation-in-part of application No. 09/927,727, filed on Aug. 10, 2001, now abandoned.

(30) Foreign Application Priority Data
Aug. 14, 2000 (NL) 1015928

(51) Int. Cl. G01V 1/40

(52) U.S. Cl. 702/6

(57) ABSTRACT

A system and corresponding method for processing drill hole data such as obtained by taking a drill hole measurement comprising dividing the drill hole measurement data into successive depth bands having a predetermined depth span, producing for each depth band a characterization of its spectral content, comparing the spectral content of a depth band with the spectral content of a next depth band and calculating an indicator that quantifies spectral change between successive depth bands, integrating the spectral change indicator with respect to depth in order to obtain a spectral trend, and scaling the spectral trend using an automatic gain control for a plurality of user defined gain windows. Also a system and method for data representation and a method for data interpretation.

### CROSS-REFERENCE TO RELATED APPLICATIONS

This application is a continuation-in-part application of U.S. patent application Ser. No. 09/927,727, entitled “System of Processing and Presenting Drill Hole Data”, to Swie Djin Nio, filed on Aug. 10, 2001, which claimed priority to Netherlands Patent Application No. 1015928, filed on Aug. 14, 2000, and the specifications thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to methods and systems for processing and presenting drill hold data.

2. Description of Related Art

In practice, data of drill hole measurements are used by the petroleum industry in the exploration and production of oil and gas in order to predict and/or to detect the possible presence of strata containing oil and/or gas deposits. A problem is, however, that the known methods of interpreting drill hole data is very cost-intensive, and presupposes an exact knowledge of the geological history of the examined terrain. There is a large variety in the types of measurement data used with this examination. For example, measurements of the natural radioactivity in the examined drill holes are used. Also, acoustic signals are used in order to determine the speed of sound in the examined stratum, which is an indirect measure of the density of that stratum.

The present invention provides a system and method with which the person skilled in the art is able to gain an accurate understanding of the geological structure of the examined domain by means of partly computerized processing of the data from the drill hole measurement. The invention makes these data of drill hole measurements available in a cost-efficient and user-friendly manner.

### BRIEF SUMMARY OF THE INVENTION

The present invention is of a system for processing drill hole data such as obtained by taking a drill hole measurement, comprising: means for dividing the drill hole measurement data into successive depth bands having a predetermined depth span; means for producing for each depth band a characterization of its spectral content; means for comparing the spectral content of a depth band with the spectral content of a next depth band and calculating an indicator that quantifies spectral change between successive depth bands; means for integrating the spectral change indicator with respect to depth in order to obtain a spectral trend; and means for scaling the spectral trend using an automatic gain control for a plurality of user defined gain windows.

The invention is also of a system for data representation, comprising: means for displaying a spectral trend curve as a function depth; means for displaying scaled spectral trend curves of a single drill hole as a function of depth and gain-window size; and means for displaying spectral trend curves of multiple drill holes. In the preferred embodiment, the invention additionally comprises means for displaying conventional drill hole data together with spectral trend curves.

The invention is further of a method for processing drill hole data such as obtained by taking a drill hole measurement, comprising: dividing the drill hole measurement data into successive depth bands having a predetermined depth span; producing for each depth band a characterization of its spectral content; comparing the spectral content of a depth band with the spectral content of a next depth band and calculating an indicator that quantifies spectral change between successive depth bands; integrating the spectral change indicator with respect to depth in order to obtain a spectral trend; and scaling the spectral trend using an automatic gain control for a plurality of user defined gain windows.

The invention is additionally of a method for data representation, comprising: displaying a spectral trend curve as a function depth; displaying scaled spectral trend curves of a single drill hole as a function of depth and gain-window size; and displaying spectral trend curves of multiple drill holes. In the preferred embodiment, the invention additionally comprises displaying conventional drill hole data together with spectral trend curves.

The invention is yet further of a method for data interpretation, comprising: based on observed changes in spectral trend curves, defining stratigraphic units; and based on a correlation between the spectral trend curves of a plurality of drill holes in an area and the stratigraphic units, deriving a model of geological structures of an examined area.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a flowchart of the method of the invention;

FIG. 2 illustrates a first embodiment of the invention;

FIG. 3 illustrates a second embodiment of the invention;

FIG. 4 is an illustrative spectral trend curve generated by the invention for Permian Rotliegend, a formation offshore the Netherlands; and

FIG. 5 is an illustrative well-to-well correlation of spectral trend curves for the same example.

### DETAILED DESCRIPTION OF THE INVENTION

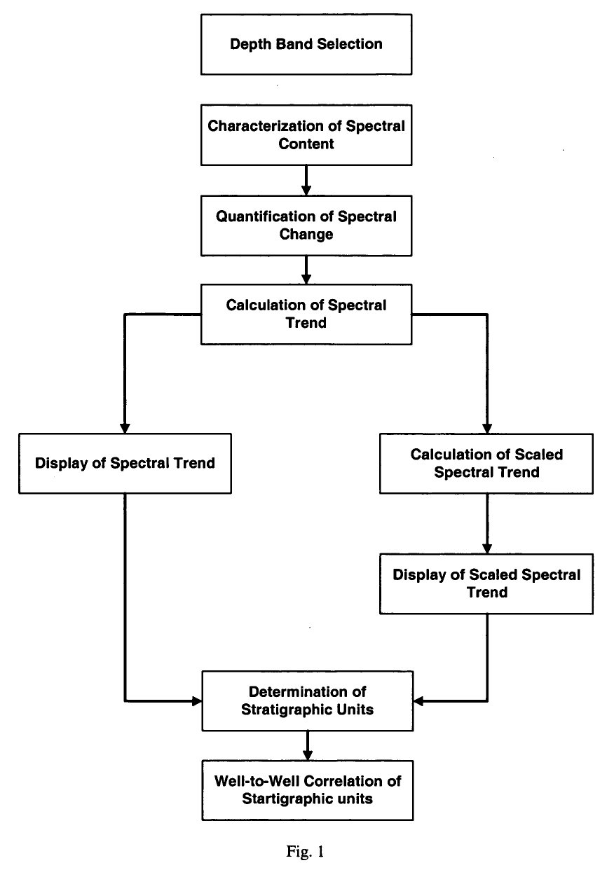

The present invention is of a system of processing and presenting drill hole data such as obtained by taking a drill hole measurement, characterized in that the drill hole measurement data are divided into successive depth bands having a predetermined depth span; for each depth band an analysis is carried out producing for each such depth band a characterization of its spectral content; the spectral content of a depth band is compared with the spectral content of the next depth band and an indicator is calculated that quantifies spectral change between successive depth bands; the spectral change indicator is integrated with respect to depth in order to obtain the spectral trend; the spectral trend curve is displayed as a function depth; the spectral trend is scaled using an automatic gain control (AGC) for a variety of user defined gain windows; the scaled spectral trend curves are displayed as a function of depth and gain-window size; the displays of spectral trend curve as well as scaled spectral trend curves are used to distinguish between the various stratigraphic units in the drill hole, thus enhancing the understanding of the geological structure in the drill hole; and the combined display of spectral trend curves for multiple drill holes in an area are used to correlate between the various stratigraphic units common to these drill holes, thus enhancing the understanding of the geological structure of the examined area. A flow chart illustrating the method of the invention is shown in FIG. 1, as would be executed on a computer system, as would be understood by one of ordinary skill in the art.

In a first aspect of the invention the system of processing and presenting data of drill hole measurements as obtained by taking a measurement in a drill hole is characterized in that the drill hole measurement data are divided into successive depth bands having a predetermined depth window; in that for each depth band an analysis is carried out producing for each such depth band a characterization of its spectral content; in that the spectral content of a depth band is compared with the spectral content of the next depth band and an indicator is calculated that quantifies spectral change between successive depth bands; and in that the spectral change indicator is integrated with respect to depth in order to obtain the spectral trend.

As already mentioned, the depth window of the various depth bands is preferably predetermined. This depth window determines the resolution and consequently the accuracy with which the drill hole measurement data can be translated into geologically relevant information.

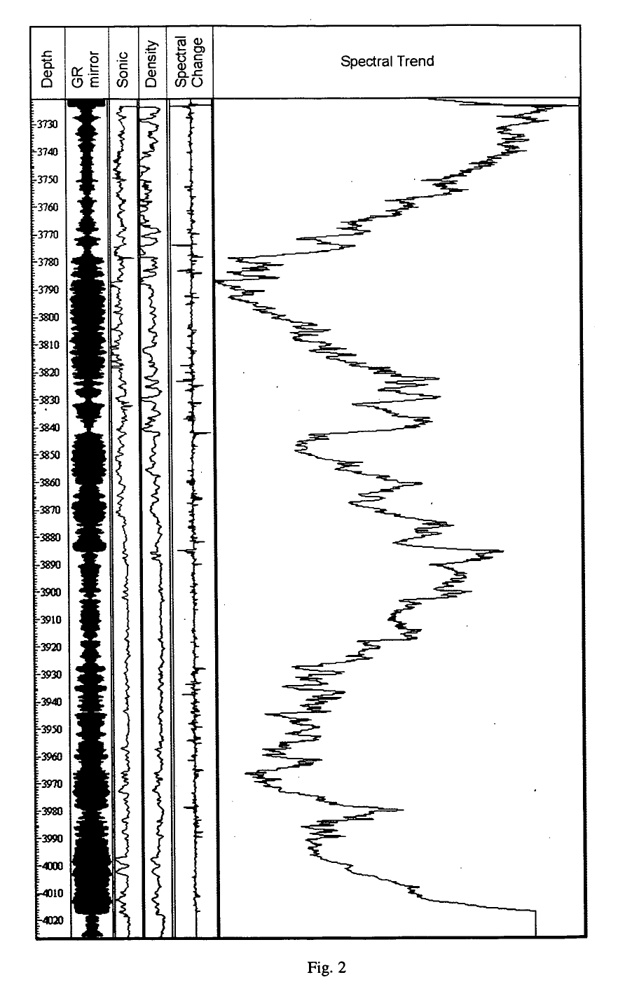

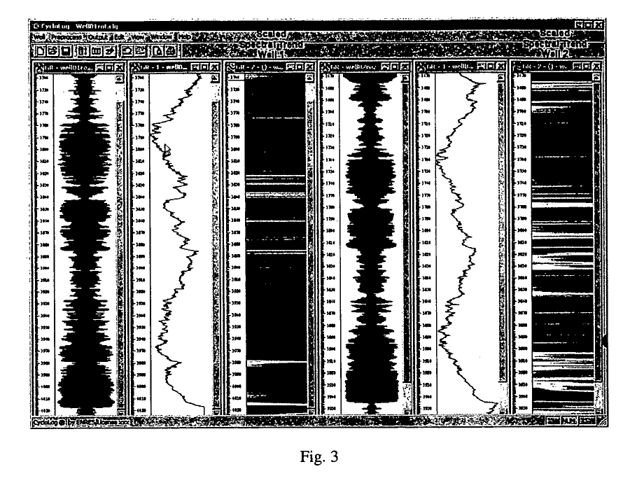

A further aspect of the invention relates to a system of data presentation. The spectral trend curve is displayed as a function of depth and, as such, may be compared to other existing drill-hole data available as a function of depth (FIG. 2). Additionally the spectral trend data may be scaled using an automatic gain control (AGC) for a variety of user defined gain windows. The resultant scaled spectral trend curves are subsequently displayed as a function of depth and gain-window size (FIG. 3).

Spectral trend curves and the above mentioned presentation of these curves render the subsequent analysis of the drill hole measurement data highly reliable, allowing the obtained drill hole measurement data to be optimally correlated with the generally available geological knowledge of the examined area.

The system according to the invention may, for example, be implemented on a stand-alone computer such as a PC to which a graphical image unit is coupled. Such a system will allow the presentation of measuring data such as shown in the appended figures. FIG. 2 shows an image as may appear on a display of a system according to the invention. The image is comprised of a left half and a right half. The left half of the image represents the conventional display of drill-hole data as a function of depth (the y-axis in the figure). The right half of the display represents the spectral trend curve again as a function of depth. Discontinuities in the trend curve are determined relative to the depth of the drill hole. Said discontinuities may entail a deviation to the left or a deviation to the right, having a particular geological significance. A deviation of this curve to the left generally signifies an increase in sediment formation, whereas a deviation to the right signifies a decrease.

FIG. 3 shows another image as it may appear on a display of a system according to the invention. The image is comprised of the scaled spectral trend displays as obtained from the analysis of two distinct drill-holes. Comparison of the two (or more) displays allows the detailed correlation of the two drill-holes in depth.

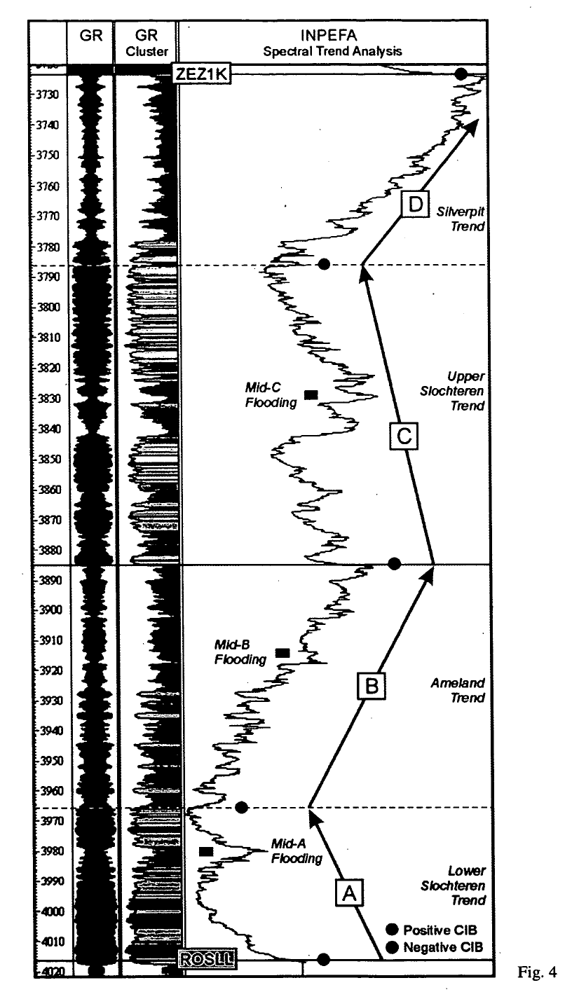

Referring to FIG. 4, the spectral trend curve generated according to the invention shows the following features:

(1) The example is from the Permian Rotliegend, Offshore Netherlands. ROSLL is the stratigraphic base of the Rotliegend. ZEZ1 K is the base of the Coppershale or stratigraphic top of the Rotliegend.

(2) The Spectral Trend Curve (INPEFA) shows two trends—a negative trend (curve to the left), and a positive trend (curve to the right).

(3) A negative trend represents geologically a “progradational” trend or an increasing “clean” sand succession upwards.

(4) A positive trend represents geologically a “retrogradational” trend or an increasing shale content upwards.

(5) The red line and red dot represent the base of a “progradational” trend and is defined as the negative Cycle Interval Boundary (CIB).

(6) The blue line and blue dot represent the base of a “retrogradational” trend and is defined as the positive Cycle Interval Boundary (CIB).

(7) Each CIB represents major near-synchronous geological events and may be used in well-to-well correlations.

(8) In the example two negative trends can be recognized—the Lower Slochteren and Upper Slochteren trends. Both are sand prone and are the major potential reservoirs.

(9) Furthermore two positive trends can be observed—the Ameland and Silverpit trends. Both are potential seals.

(10) Spectral trend curves according to the invention may be used for well-to-well correlations and stratigraphic or sedimentological interpretations.

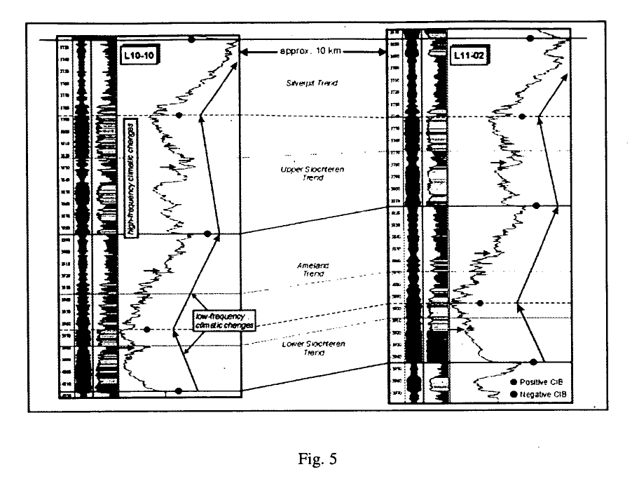

Referring to FIG. 5, the well-to-well correlation of the spectral trend curves shows the following features:

(1) The remarkable similarity of the spectral trend curve pattern. Long-term as well as short term cycle patterns can be correlated in great detail.

(2) The onset of a sand prone interval (negative CIBs) can be recognized and represents a near-synchronous basin event. In sequence stratigraphic terms, these negative CIBs may be similar as sequence boundaries.

(3) The onset of a shaly interval (positive CIBs) are in sequence stratigraphic terms the flooding surfaces and can be correlated in great detail and confidence.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A system for processing drill hole data such as obtained by taking a drill hole measurement, said system comprising:
means for dividing the drill hole measurement data into successive depth bands having a predetermined depth span;
means for producing for each depth band a characterization of its spectral content;
means for comparing the spectral content of a depth band with the spectral content of a next depth band and calculating an indicator that quantifies spectral change between successive depth bands;
means for integrating the spectral change indicator with respect to depth in order to obtain a spectral trend; and
means for scaling the spectral trend using an automatic gain control for a plurality of user defined gain windows.

2. A system for data representation, said system comprising:
means for displaying a spectral trend curve as a function depth;
means for displaying scaled spectral trend curves of a single drill hole as a function of depth and gain-window size; and
means for displaying spectral trend curves of multiple drill holes.

3. The system of claim 2 additionally comprising means for displaying conventional drill hole data together with spectral trend curves.

4. A method for processing drill hole data such as obtained by taking a drill hole measurement, the method comprising the steps of:
dividing the drill hole measurement data into successive depth bands having a predetermined depth span;
producing for each depth band a characterization of its spectral content;
comparing the spectral content of a depth band with the spectral content of a next depth band and calculating an indicator that quantifies spectral change between successive depth bands;
integrating the spectral change indicator with respect to depth in order to obtain a spectral trend; and
scaling the spectral trend using an automatic gain control for a plurality of user defined gain windows.

5. A method for data representation, the method comprising the steps of:
displaying a spectral trend curve as a function depth;
displaying scaled spectral trend curves of a single drill hole as a function of depth and gain-window size; and
displaying spectral trend curves of multiple drill holes.

6. The method of claim 2 additionally comprising the step of displaying conventional drill hole data together with spectral trend curves.

7. A method for data interpretation, the method comprising the steps of:
based on observed changes in spectral trend curves, defining stratigraphic units; and
based on a correlation between the spectral trend curves of a plurality of drill holes in an area and the stratigraphic units, deriving a model of geological structures of an examined area.
